(19) United States
(12) Patent Application Publication
(10) Pub. No.: US 2025/0236142 A1
(43) Pub. Date: Jul. 24, 2025

(54) TIRE PRESSURE MONITORING SYSTEM FOR PREDICTIVE MAINTENANCE

(71) Applicant: Sensata Technologies, Inc., Attleboro, MA (US)

(72) Inventor: Eugene P. Brennan, Kilrea (IE)

(21) Appl. No.: 19/023,697

(22) Filed: Jan. 16, 2025

Related U.S. Application Data
(60) Provisional application No. 63/622,230, filed on Jan. 18, 2024.

(51) Int. Cl. B60C 23/04; B60C 11/24

(52) U.S. Cl. CPC B60C 23/0476; B60C 11/246; B60C 23/0471

(57) ABSTRACT

Embodiments included herein are directed towards tire pressure monitoring. Embodiments of the present disclosure may include receiving temperature and history over multiple events of an individual tire and determining a first indication by comparing a relative temperature between various tires during an operation to predict a tire blow out scenario in a vehicle. Embodiments may also include determining a second indication by reviewing decrease in pressure of a wheel of the individual tire over time and comparing the decreased pressure of the wheel with other wheels of the various tires on the vehicle using an algorithm on a system level. Embodiments may further include forming predictive analysis based on the first indication and second indication to recommend further manual investigation of a vehicle usability as an aid in preventive maintenance of the vehicle. Embodiments may further include displaying the recommendation for the preventive maintenance of the vehicle to a user.

### CROSS-REFERENCE TO RELATED APPLICATIONS

The present application claims the benefit of U.S. Provisional Patent Application No. 63/622,230, entitled “Tire Pressure Monitoring System for Predictive Maintenance”, filed on 18 Jan. 2024. The entire disclosure of which is incorporated herein by reference.

### TECHNICAL FIELD

The present disclosure generally applies to monitoring systems, more specifically a system and method for a tire pressure monitoring system.

### BACKGROUND

Tire pressure monitoring systems (“TPMS”) are electrical systems designed to monitor the air pressure inside the tires of vehicles. Sensors of the TPMS are mounted in each wheel of the vehicles constantly measure a tire's pressure and, if mounted inside the tire, its temperature. This information is transmitted wirelessly and displayed by either an in-cab display or a technician's hand-held device during maintenance checks. These systems generally operate in real-time periodically measuring tire pressure to help avoid traffic accidents, poor fuel economy, and improve wear on the tires. Numerous countries around the world mandate these systems in vehicles because of their effectiveness in creating a safer driving environment.

### SUMMARY OF THE DISCLOSURE

As will be discussed in greater detail below, embodiments of the present disclosure include a tire pressure monitoring system.

In one or more embodiments of the present disclosure, a method, computer program product, and computing system associated with a tire pressure monitoring system (“TPMS”) is included. The method may include receiving temperature and history over multiple events of an individual tire. The method may further include determining a first indication by comparing a relative temperature between various tires during an operation to predict a tire blow out scenario in a vehicle. The method may also include determining a second indication by reviewing decrease in pressure of a wheel of the individual tire over time and comparing the decreased pressure of the wheel with other wheels of the various tires on the vehicle using an algorithm on a system level. The method may further include forming predictive analysis based on the first indication and second indication to recommend further manual investigation of a vehicle usability as an aid in preventive maintenance of the vehicle. The method may further include displaying the recommendation for the preventive maintenance of the vehicle to a user on a user electronic device.

One or more of the following features may be included. In some embodiments, the method may include calculating a crude mileage by coupling the history over multiple events of the individual tire with data from a length of service of the individual tire, number or roll events and a duration. In some embodiments, the calculation of the crude mileage determines an early identification of wear or tread depth nearing end of life of the individual tire. In some embodiments, the relative temperature between the various tires is compared in partnership with at least a tire identification or other derived tire pairing technique. In some embodiments, the method may further include calculating a battery life for a remaining capacity of a battery of the TPMS by using the data from the roll events and the crude mileage. In some embodiments, the first indication is a precursory indication mechanism in the prediction of the tire blow out scenario of the vehicle. In some embodiments, the second indication is a puncture indication and the second indication is determined by partnering the first indication with an application for reviewing decrease in pressure of the wheel of the individual tire over time and comparing the decreased pressure of the wheel with the other wheels of the various tires on the vehicle.

In another embodiment of the present disclosure, a non-transitory computer readable storage medium having stored thereon instructions, which when executed by a processor result in one or more operations is provided. Operations may include receiving temperature and history over multiple events of an individual tire. The operations may further include determining a first indication by comparing a relative temperature between various tires during an operation to predict a tire blow out scenario in a vehicle. The operations may also include determining a second indication by reviewing decrease in pressure of a wheel of the individual tire over time and comparing the decreased pressure of the wheel with other wheels of the various tires on the vehicle using an algorithm on a system level. The operations may further include forming predictive analysis based on the first indication and second indication to recommend further manual investigation of a vehicle usability as an aid in preventive maintenance of the vehicle. The operations may further include displaying the recommendation for the preventive maintenance of the vehicle to a user on a user electronic device.

One or more of the following features may be included. In some embodiments, the calculation of the crude mileage determines an early identification of wear or tread depth nearing end of life of the individual tire. In some embodiments, the relative temperature between the various tires is compared in partnership with at least a tire identification or other derived tire pairing technique. In some embodiments, the first indication is a precursory indication mechanism in the prediction of the tire blow out scenario of the vehicle. In some embodiments, the second indication is a puncture indication and the second indication is determined by partnering the first indication with an application for reviewing decrease in pressure of the wheel of the individual tire over time and comparing the decreased pressure of the wheel with the other wheels of the various tires on the vehicle.

In one or more embodiments of the present disclosure, a TPMS is provided. The TPMS may include a receiver, a plurality of antilock brake system (ABS) sensors, an Electronic Control Unit (ECU) including a processor and a storage, and a plurality of wheel units. The ECU is coupled to the plurality of ABS sensors. At least one wheel unit includes one or more of: a microcontroller, a battery, a transponder coil, a sensor interface, a pressure sensor, a wheel phase angle sensor, a transmitter, and an antenna. The microcontroller is coupled to the sensor interface and the sensor interface is coupled to the wheel phase angle sensor. The processor is configured to receive temperature and history over multiple events of an individual tire via the receiver. The processor is further configured to determine a first indication by comparing a relative temperature between various tires during an operation to predict of a tire blow out scenario. The processor is further configured to determine a second indication by reviewing decrease in pressure of a wheel of the individual tire over time and comparing the decreased pressure of the wheel with other wheels of the various tires on a vehicle using an algorithm on a system level. The processor is further configured to form predictive analysis based on the first indication and second indication to recommend further a manual investigation of a vehicle usability as an aid in a preventive maintenance of the vehicle. The processor is further configured to display the recommendation for the preventive maintenance of the vehicle to a user on a user electronic device.

One or more of the following features may be included. In some embodiments, the processor is further configured to calculating a crude mileage by coupling the history over multiple events of the individual tire with data from a length of service of the individual tire, number or roll events and a duration. In some embodiments, the calculation of the crude mileage determines an early identification of wear or tread depth nearing end of life of the individual tire. In some embodiments, the relative temperature between the various tires is compared in partnership with at least a tire identification or other derived tire pairing technique. In some embodiments, the processor is further configured to calculating a battery life for a remaining capacity of a battery of the TPMS by using the data from the roll events and the crude mileage. In some embodiments, the first indication is a precursory indication mechanism in the prediction of the tire blow out scenario of the vehicle and the second indication is a puncture indication. In some embodiments, the second indication is determined by partnering the first indication with an application for reviewing decrease in pressure of the wheel of the individual tire over time and comparing the decreased pressure of the wheel with the other wheels of the various tires on the vehicle.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

This summary is provided to introduce a selection of concepts that are further described below in the detailed description. This summary is not intended to identify essential features of the claimed subject matter, nor is it intended to be used as an aid in limiting the scope of the claimed subject matter.

### BRIEF DESCRIPTION OF THE DRAWINGS

The accompanying drawings, which are included to provide a further understanding of embodiments of the present disclosure and are incorporated in and constitute a part of this specification, illustrate embodiments of the present disclosure and together with the description serve to explain the principles of embodiments of the present disclosure.

FIG. 1 is an example diagrammatic view of a tire pressure monitoring system coupled to an example distributed computing network according to one or more example implementations of the disclosure;

FIG. 2 illustrates one embodiment of the tire pressure monitoring system in accordance with embodiments of the present disclosure;

FIG. 3 illustrates one embodiment of a wheel unit for use with the tire pressure monitoring system in accordance with embodiments of the present disclosure;

FIG. 4 illustrates a schematic illustrating an application based level implementation of a predictive analysis algorithm in accordance with embodiments of the present disclosure;

FIG. 5 illustrates a flowchart in accordance with embodiments of the present disclosure;

Like reference symbols in the various drawings may indicate like elements.

### DETAILED DESCRIPTION

The discussion below is directed to certain implementations. It is to be understood that the discussion below is only for the purpose of enabling a person with ordinary skill in the art to make and use any subject matter defined now or later by the patent “claims” found in any issued patent herein.

It is specifically intended that the claimed combinations of features not be limited to the implementations and illustrations contained herein, but include modified forms of those implementations including portions of the implementations and combinations of elements of different implementations as come within the scope of the following claims. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the claimed invention unless explicitly indicated as being “critical” or “essential.”

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered a same object or step.

In commercial vehicles, there is a continual need in the TPMS market for increasing the life of the system to reduce down time and increase the effectiveness of this important safety system by remembering when to check tires and an additional comfort measure in safety. The purpose of this is to inform the driver of an unsafe operating mode relating to one, or all of the tires on the vehicle.

The present disclosure is directed to a method, computer program product, and computing system associated with a tire pressure monitoring system (“TPMS”). In accordance with various embodiments of the present disclosure, using current and historic raw data from the TPMS unit and other available data inputs from a vehicle together form algorithms for a retrofit ability to perform a predictive analysis based on a first indication and a second indication to recommend further manual investigation of the vehicle usability as an aid in preventive maintenance of the vehicle and allowing an operator/a user the opportunity to take precautionary countermeasures ahead of time. The first indication may be determined by comparing a relative temperature between various tires during an operation to predict a tire blow out scenario in the vehicle. The second indication may be determined by reviewing decrease in pressure of a wheel of the individual tire over time, comparing the decreased pressure of the wheel with other wheels of the various tires on the vehicle using an algorithm at a system level, and then forming a predictive analysis to recommend and display to the owner/user that usability of the vehicle requires further investigation as an aid in preventive maintenance on a personal digital assistant of the owner/user. The system level comparison may not require to be confined to the vehicle, but may also be provided as a cloud, app based level or equivalent. In some embodiments, the preventative maintenance determination may use trending analysis software or include synthetic trending using machine learning, artificial intelligence (AI) or host algorithm on any hardware of a virtual device capable of hosting, executing the algorithm and notifying/updating any interested parties. In some embodiments, the information above is not limited to the tire but also other serviceable items in the same vicinity such as wheel bearings, track rod ends, suspension bushings, etc.

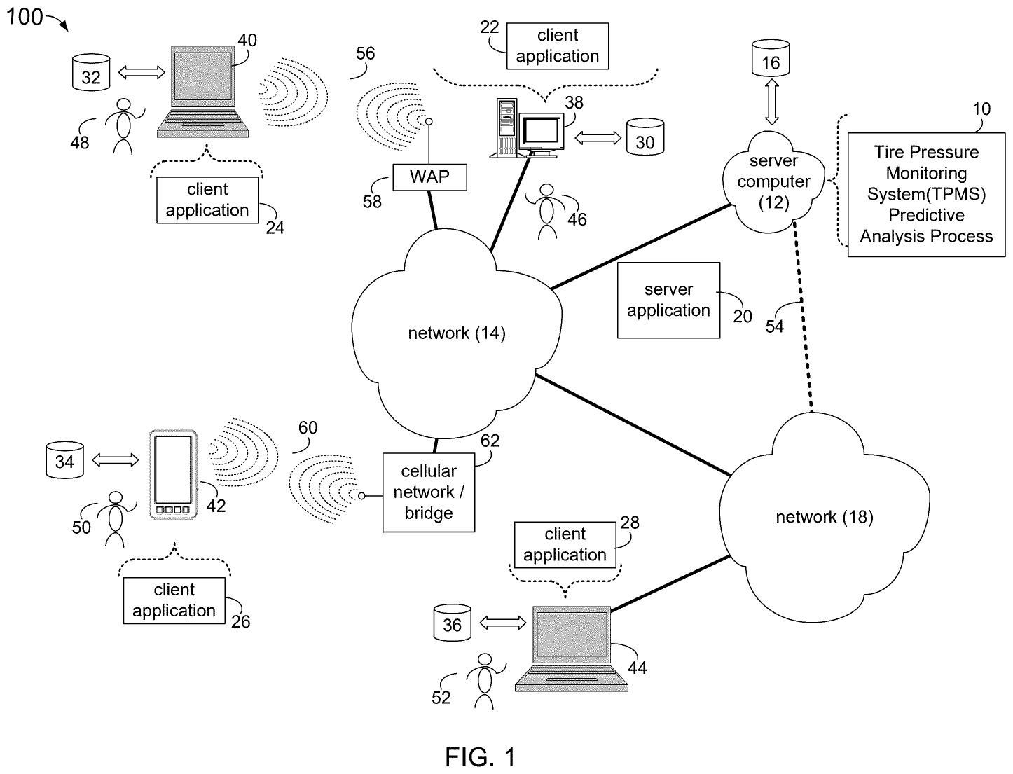

Referring to FIG. 1, there is shown a tire pressure monitoring system (“TPMS”) predictive analysis process 10 that may reside on and may be executed by server computer 12, which may be connected to network 14 (e.g., the Internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both). Additionally and/or alternatively, the TPMS predictive analysis process 10 may reside on a client electronic device, such as a personal computer, notebook computer, personal digital assistant, or the like.

The instruction sets and subroutines of the TPMS predictive analysis process 10, which may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID device; a random-access memory (RAM); a read-only memory (ROM); and all forms of flash memory storage devices. Additionally/alternatively, some portions of the instruction sets and subroutines of the TPMS predictive analysis process 10 may be stored on storage devices (and/or executed by processors and memory architectures) that are external to storage device 16.

Server computer 12 may execute a web server application, examples of which may include but are not limited to: Microsoft IIS™, Novell Webserver™, or Apache Webserver™, that allows for HTTP (i.e., HyperText Transfer Protocol) access to server computer 12 via network 14. Network 14 may be connected to one or more secondary networks (e.g., network 18), examples of which may include but are not limited to: a local area network; a wide area network; or an intranet, for example.

Server computer 12 may execute one or more server applications (e.g., server application 20), examples of which may include but are not limited to, e.g., Lotus Domino™ Server and Microsoft Exchange™ Server. Server application 20 may interact with one or more client applications (e.g., client applications 22, 24, 26, 28) in order to execute the TPMS predictive analysis process 10. In some embodiments, the TPMS predictive analysis process 10 may be stand-alone application that interface with server application 20 or may be applets/applications that may be executed within server application 20.

The instruction sets and subroutines of server application 20, which may be stored on storage device 16 coupled to server computer 12, may be executed by one or more processors (not shown) and one or more memory architectures (not shown) incorporated into server computer 12.

As mentioned above, in addition/as an alternative to being server-based applications residing on server computer 12, the TPMS predictive analysis process 10 may be client-side application residing on one or more client electronic devices 38, 40, 42, 44 (e.g., stored on storage devices 30, 32, 34, 36, respectively). As such, the TPMS predictive analysis process 10 may be stand-alone application that interfaces with a client application (e.g., client applications 22, 24, 26, 28) or may be applets/applications that may be executed within a client application. As such, the TPMS predictive analysis process 10 may be client-side processes, server-side processes, or hybrid client-side/server-side processes, which may be executed, in whole or in part, by server computer 12, or one or more of client electronic devices 38, 40, 42, 44.

Network 14 may be connected to one or more secondary networks (e.g., network 18), examples of which may include but are not limited to: a local area network; a wide area network; or an intranet, for example.

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID arrays; random access memories (RAM); read-only memories (ROM), compact flash (CF) storage devices, secure digital (SD) storage devices, and memory stick storage devices. Examples of client electronic devices 38, 40, 42, 44 may include, but are not limited to, personal computer 38, laptop computer 40, personal digital assistant 42, notebook computer 44, a data-enabled, cellular telephone (not shown), and a dedicated network device (not shown), for example. Using client applications 22, 24, 26, 28, users 46, 48, 50, 52 may utilize formal analysis, testbench simulation, and/or hybrid technology features to verify a particular integrated circuit design.

Users 46, 48, 50, 52 may access server application 20 directly through the device on which the client application (e.g., client applications 22, 24, 26, 28) is executed, namely client electronic devices 38, 40, 42, 44, for example. Users 46, 48, 50, 52 may access server application 20 directly through network 14 or through secondary network 18. Further, server computer 12 (e.g., the computer that executes server application 20) may be connected to network 14 through secondary network 18, as illustrated with phantom link line 54.

In some embodiments, the TPMS predictive analysis process 10 may be cloud-based process as any or all of the operations described herein may occur, in whole, or in part, in the cloud or as part of a cloud-based system. The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (e.g., WAP) 58, which is shown directly coupled to network 14. WAP 58 may be, for example, an IEEE 802.11a, 802.11b, 802.11g, 802.11n, Wi-Fi, and/or Bluetooth device that is capable of establishing wireless communication channel 56 between laptop computer 40 and WAP 58. Personal digital assistant 42 is shown wirelessly coupled to network 14 via wireless communication channel 60 established between personal digital assistant 42 and cellular network/bridge 62, which is shown directly coupled to network 14.

As is known in the art, all of the IEEE 802.11x specifications may use Ethernet protocol and carrier sense multiple access with collision avoidance (CSMA/CA) for path sharing. The various 802.11x specifications may use phase-shift keying (PSK) modulation or complementary code keying (CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft® Windows®; Mac® OS X®; Red Hat® Linux®, Windows® Mobile, Chrome OS, Blackberry OS, Fire OS, or a custom operating system.

In some implementations, as will be discussed below in greater detail, the TPMS predictive analysis process 10 of FIG. 1, may include but is not limited to, receiving temperature and history over multiple events of an individual tire. The first indication may be determined by comparing a relative temperature between various tires during an operation to predict a tire blow out scenario in a vehicle. The second indication may be determined by reviewing decrease in pressure of a wheel of the individual tire over time and comparing the decreased pressure of the wheel with other wheels of the various tires on the vehicle using an algorithm on a system level. A predictive analysis may be formed based on the first indication and second indication to recommend further manual investigation of a vehicle usability as an aid in a preventive maintenance of the vehicle. The recommendation may be displayed for the preventive maintenance of the vehicle to a user on a personal digital assistant of the user. The system level comparison may not require to be confined to the vehicle, but may also be provided as a cloud, app based level or equivalent.

For example, purposes only, server computer 12 may be described as being a network-based server computer that includes a plurality of electro-mechanical backend storage devices. However, this is for example purposes only and is not intended to be a limitation of this disclosure, as other configurations are possible and are considered to be within the scope of this disclosure.

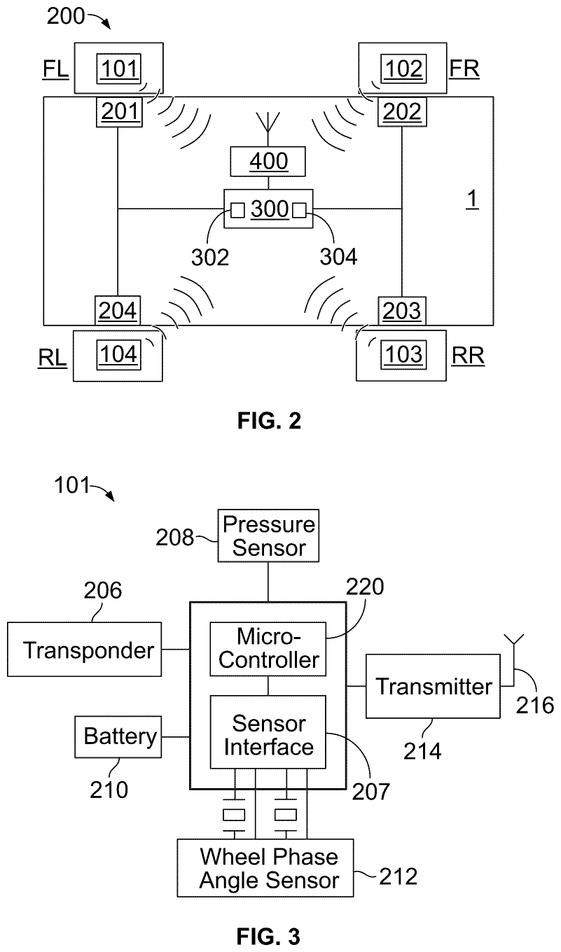

FIG. 2 illustrates a tire pressure monitoring system (“TPMS”) 200 according to a first embodiment of the present disclosure, which may be in communication, in whole or in part, with the network shown in FIG. 1. TPMS 200 may be arranged in a standard vehicle 1 having four wheels. Four wheels include a front left wheel (FL), a front right wheel (FR), a rear left wheel (RL) and a rear right wheel (RR). In another embodiment, TPMS 200 may be arranged in any other vehicle having a different number of wheels. TPMS 200 may include wheel units 101, 102, 103 and 104 that may be associated with each wheel of vehicle 1.

In some embodiments, TPMS 200 may further include four antilock brake system (ABS) sensors 201, 202, 203 and 204. ABS sensors 201-204 may also be associated with each wheel of vehicle 1. Accordingly, each wheel may be assigned with one of wheel units 101, 102, 103 and 104 and one of ABS sensors 201, 202, 203 and 204.

In some embodiments, TPMS 200 may also include an Electronic Control Unit (ECU) 300 and a receiver 400. ECU 300 may be coupled to ABS sensors 201-204 via a communication bus such as a Controller Area Network (CAN) bus and may receive ABS data from ABS sensors 201-204. ECU 300 may include processor 302 and storage 304. ECU 300 operates to store received ABS data in storage 304 to provide a historic ABS trace. ECU 300 may be implemented by any suitable means, for example a microprocessor, microcontroller, an Application Specific Integrated Circuit (ASIC), or other suitable data processing device programmed to perform the functions described herein. Further, ECU 300 may communicate with other vehicle components using any other suitable device, either wire line or wireless. The CAN bus is an exemplary implementation of data communication among components of the vehicle.

In some embodiments, ECU 300 may also receive data from wheel units 101, 102, 103 and 104 via receiver 400. For example, wheel units 101, 102, 103 and 104 transmit radio frequency or other wireless communications conveying data and other information to ECU 300. The respective wheel units may include a suitable radio transmission circuit and ECU 300 includes a suitable radio reception circuit for radio communication. Further, the radio circuits may use an agreed upon transmission and reception format and data encoding technique. ECU 300 operates to correlate the data received from wheel units 101, 102, 103 and 104 with the ABS data in order to perform auto-location, as will be discussed in detail below.

Referring to FIG. 3, the structure of wheel unit 101 is illustrated in more detail. Wheel units 102-104 may incorporate the same structure as that of wheel unit 101. As shown in FIG. 3, wheel unit 101 includes a microcontroller 220, a battery 210, a transponder coil 206, a sensor interface 207, a pressure sensor 208, a wheel phase angle sensor 212, a transmitter 214 and an antenna 216. Microcontroller 220 is coupled to sensor interface 207. Sensor interface 207 is coupled to wheel phase angle sensor 212. Wheel phase angle sensor 212 measures a wheel phase angle at multiple different times. Wheel phase angle sensor 212 provides measurements to sensor interface 207. Sensor interface 207 may receive the measurements of wheel phase angle sensor 212 in the form of an electrical output signal. Sensor interface 207 may receive the electrical output signal and amplifies and filters the signal. Sensors mounted in each wheel of the vehicle constantly measure a tire's pressure and, if mounted inside the tire, its temperature. This information is transmitted wirelessly to sensor interface 207 and displayed by either an in-cab display or a technician's hand-held device during maintenance checks. Sensor interface 207 may send the processed signal to an analog to digital converter (not shown) in order to convert the signal into a digital signal. Microcontroller 220 may receive the digital form of the output signal from wheel phase angle sensor 212 for processing.

In the illustrated embodiment, pressure sensor 208 may detect the pneumatic air pressure of the tire with which wheel unit 101 is associated. In alternative embodiments, pressure sensor 208 may be supplemented with or replaced by a temperature sensor or other devices for detecting tire data. An indication of the tire pressure data is sent to microcontroller 220 via the analog-to-digital converter (not shown).

In some embodiments, battery 210 may be a power source of wheel unit 101. Transponder coil 206 may detect external activation of the transponder by a signal applied by a remote exciter and may modulate a signal to communicate data to a remote detector from wheel unit 101. Wheel unit 101 may provide data including tire pressure from the pressure sensor 208 and the wheel phase angle information from wheel phase angle sensor 212 through transmitter 214 and antenna 216 to ECU 300 (as shown in FIG. 2).

In operation, upon rotation of a wheel, wheel phase angle sensor 212 may operate to measure a wheel phase angle. The wheel phase angle measurements may not have to be against an absolute reference. In other words, the phase measurements do not have to be measured from a top of wheel, or road striking point. The key piece of information may be a phase difference, or a phase delta of the wheel, and therefore, the requirement is that two different phase angles are measured relative to the same angle. The reference may be arbitrarily selected based on accuracy capability and ease of implementation. Wheel phase angle sensor 212 may be mounted on a rim of the wheel, or a tire mounted sensor. Alternatively, or additionally, wheel phase angle sensor 212 may be arranged on any suitable location associated with a wheel. In one embodiment, wheel phase angle 212 includes a rotation sensor. For example, the rotation sensor may be a piezoelectric rotation sensor which measures a wheel phase angle based on the gravitational force. Specifically, as the wheel rotates, the gravitational force causes a sensing element of the rotation sensor to experience different forces which results in a different output signal representing a wheel phase angle or wheel angular position. In that way, the rotation sensor produces an output signal indicating a wheel phase angle at a predetermined time. The output signal of the rotation sensor may have different amplitude and/or different polarity depending on the wheel phase angle. For instance, the rotation sensor produces the output signal having amplitude M at 0 degree and having the amplitude-M at 180 degree. Alternatively, or additionally, any conventional rotation sensor may be used as wheel phase angle sensor 212.

In another embodiment, wheel phase angle sensor 212 comprises a shock sensor of the type that produces an electrical signal in response to acceleration. The electrical signal is indicative of, or typically proportional to, the experienced change in acceleration. Alternatively, wheel phase angle sensor 212 may each comprise an accelerometer or a micro-electromechanical systems (MEMS) sensor. The main difference between an accelerometer and a shock sensor is that the output signal from a shock sensor is related to a change of force applied to the shock sensor, whereas the output signal from an accelerometer is proportional to the absolute force applied.

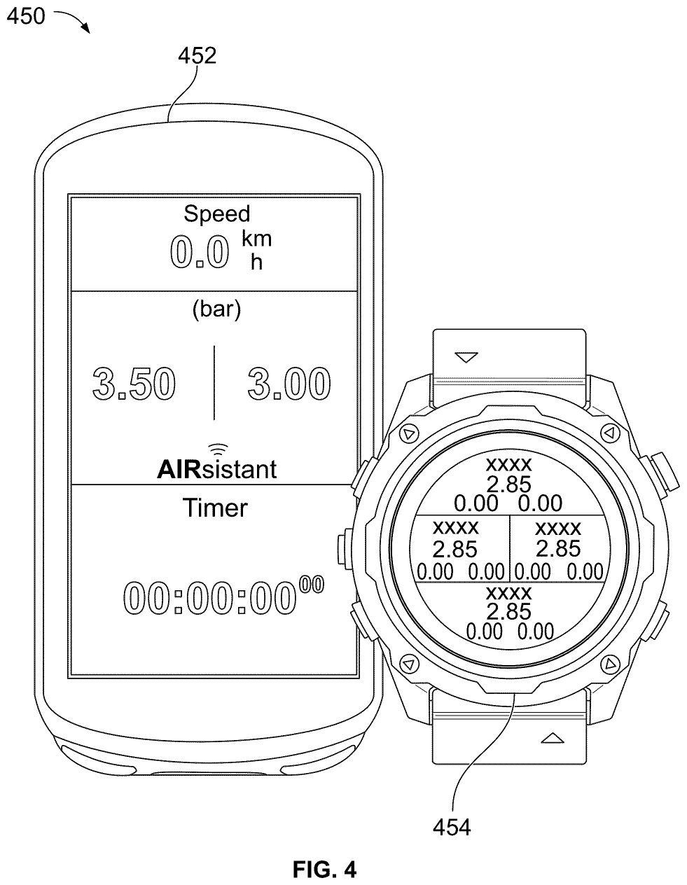

Referring now to FIG. 4, a schematic 450 illustrating an application based level implementation of a predictive analysis algorithm in accordance with embodiments of TPMS 200 is provided. FIG. 4 illustrates client electronic devices 452 and 454 as examples of electronic devices in which the application based level of the predictive analysis algorithm may be implemented. Examples of the application based level of the predictive analysis algorithm may include a dedicated software program which may be accessed via remote login, the application hosted on a smart device or a customized handheld or workshop tool. Client electronic devices 452 and 454 may each execute an operating system, examples of which may include but are not limited to Microsoft® Windows®; Mac® OS X®; Red Hat® Linux®, Windows® Mobile, Chrome OS, Blackberry OS, Fire OS, or a custom operating system. It should be noted that while certain examples are provided in FIG. 4, it is envisioned that the content described herein may be displayed on any suitable graphical user interface, including, but not limited, to those depicted in FIGS. 1-3 as well as those located within vehicles, airplanes, etc.

In some embodiments, a typical display of the application based level of the predictive analysis algorithm on client electronic devices 452 and 454 obtained from TPMS 200 usually provides alerts that notify a driver of potential problems depending on the severity of the situation.

A non-exhaustive listing of some possible alerts that may be used in accordance with the present disclosure are provided below.

Pressure deviation alert: If a tire deviates a designated percentage from its proper inflation pressure, TPMS 200 may activate a warning light and, possibly, an audible alarm on client electronic devices 452 and 454.

Critical low-pressure alert: This alert on client electronic devices 452 and 454 activates when a tire's pressure falls significantly below its cold inflation pressure value (usually set at 20 percent). This visual and audible warnings for the driver represent the need to take immediate action.

High-temperature alert: In some embodiments, TPMS 200 equipped with temperature-measuring in tire sensors, this alert may signal a high tire temperature that exceeds a predefined threshold-typically 185 degrees Fahrenheit. High tire temperatures may be usually caused by underinflation, which means that low pressure alerts may typically occur well in advance of a high-temperature alert. Triggered on its own, this alert on client electronic devices 452 and 454 may indicate an alternative problem, such as a dragging brake or wheel bearing failure.

Low sensor battery alert: This alert on client electronic devices 452 and 454 activates when the battery in a sensor nears the end of its life, it should be replaced as soon as possible to ensure continued accurate measurement.

In one or more embodiments, these alerts on client electronic devices 452 and 454 to provide a retrofit ability to perform preventative maintenance may vary depending on TPMS 200, as well as a system's pressure and temperature thresholds. In some embodiments, more advanced TPMS systems offer customization of the alerts based on a fleet's or driver's needs and operating conditions.

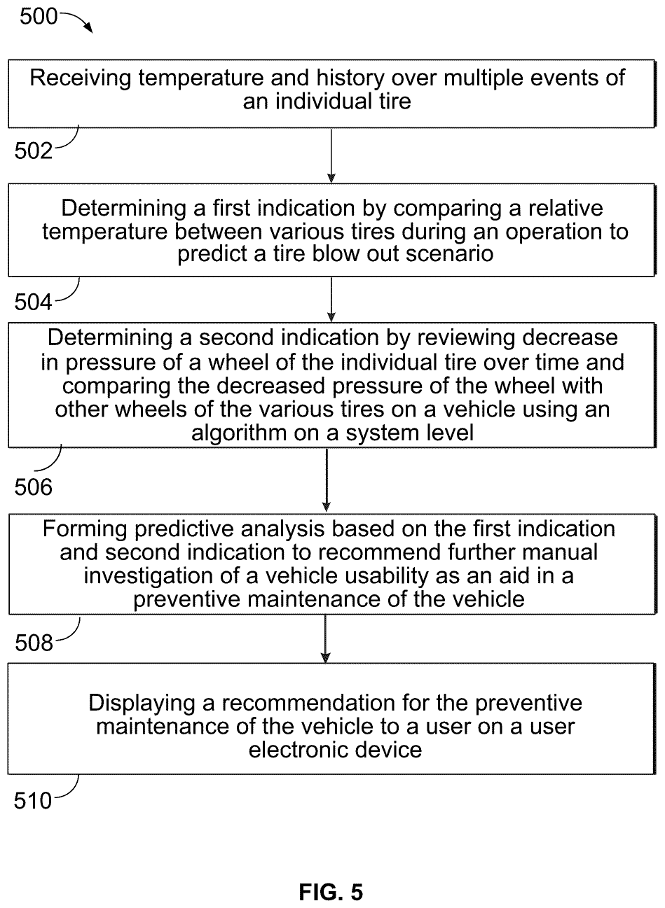

Referring now to FIG. 5, a flowchart illustrating a method, computer program product, and computing system associated with TPMS 200 in accordance with embodiments of the present disclosure is shown. A method 500 may include receiving (502) temperature and history over multiple events of an individual tire (e.g., receive data from the wheel units 101, 102, 103 and 104 via the receiver 400 of FIG. 2). The method 500 may further include determining (504) a first indication by comparing a relative temperature between various tires during an operation to predict a tire blow out scenario in a vehicle (e.g., vehicle 1). In some embodiments, the first indication is a precursory indication mechanism in the prediction of the tire blow out scenario of the vehicle. For example, a comparison of a relative temperature between various tires, in partnership with at least a tire identification or other derived tire pairing technique, during operation may highlight outliers in a distribution which may be used as a precursory indication mechanism (e.g., first indication) in the prediction of the tire blow out scenario in the vehicle.

In some embodiments, the method 500 may also include determining (506) a second indication by reviewing decrease in pressure of a wheel of the individual tire over time and comparing the decreased pressure of the wheel with other wheels of the various tires on the vehicle (e.g., vehicle 1) using an algorithm on a system level. In some embodiments, the second indication may be a puncture indication and the second indication may be determined by partnering the first indication (precursory indication mechanism) with an application for reviewing decrease in pressure of the wheel of the individual tire over time and comparing the decreased pressure of the wheel (e.g., the wheel units 101, 102, 103 and 104) with the other wheels (e.g., the wheel units 101, 102, 103 and 104) of the various tires on the vehicle (e.g., vehicle 1) using the algorithm on the system level.

In some embodiments, the method 500 may further include forming (508) a predictive analysis based on the first indication (precursory indication mechanism) and second indication (puncture indication) to recommend further manual investigation of a vehicle usability as an aid in a preventive maintenance of the vehicle. For example, using algorithmic comparison between sensors (e.g., ABS sensors 201-204, pressure sensor 208 and wheel phase angle sensor 212) at a system level (e.g., TPMS 200) and then forming the predictive analysis algorithm to recommend to the owner/user that the vehicle usability requires further investigation as an aid in the preventive maintenance. For example, the algorithmic comparison may include calculating a crude mileage by coupling the history over multiple events of the individual tire with data from a length of service of the individual tire, number or roll events and a duration. For example, the history over multiple events of the individual tire coupled with length of service of the tire, number or roll events and duration may be used as the crude mileage calculation giving an early identification of wear or tread depth nearing end of life. In some embodiments, these indicators may then be passed onto a user, an owner, and/or a tire service provider as an indicator, for further manual checking to take place of the tire. In some embodiments, the preventative maintenance determination may use trending analysis software or include synthetic trending using machine learning, AI or host algorithm on any hardware of a virtual device capable of hosting, executing the algorithm and notifying/updating any interested parties. In one or more embodiments, the information above is not limited to the tire but may also include other serviceable items in a same vicinity such as wheel bearings, track rod ends, suspension bushings etc.

In some embodiments, the algorithmic comparison may further include calculating a battery life for a remaining capacity of a battery (e.g., battery 210) of the TPMS (e.g., TPMS 200) by using the data from the roll events and the crude mileage. For example, when battery 210 of TPMS 200 nears the end of its life, battery 210 should be replaced as soon as possible to ensure continued accurate measurement by activating an alert on client electronic devices 452 and 454. In some embodiments, the information above is not limited to the tire but also other serviceable items in the same vicinity such as wheel bearings, track rod ends, suspension bushings etc. In some embodiments, the system level comparison may not require to be confined to the vehicle, but may also be provided as a cloud-based process as any or all of the operations described herein may occur, in whole, or in part, in the cloud or as part of a cloud-based system, app based level or equivalent, as shown in FIG. 4.

In some embodiments, the method 500 may further include displaying (510) the recommendation for the preventive maintenance of the vehicle to a user on a user electronic device or within a vehicle (e.g., automobile, aircraft, etc.). For example, the recommendation for the preventive maintenance of the vehicle may be displayed to the user on the user electronic device (e.g., client electronic devices 38, 40, 42, 44 executing client applications 22, 24, 26, 28). Examples of the application based level of the predictive analysis algorithm may include a dedicated software program which may be accessed via remote login, the application hosted on a smart device or a customized handheld or workshop tool. In some embodiments, the method 500 may be cloud-based process as any or all of the operations described herein may occur, in whole, or in part, in the cloud or as part of a cloud-based system. The various client electronic devices may be directly or indirectly coupled to network 14 (or network 18) as shown in FIG. 1. For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (e.g., WAP) 58, which is shown directly coupled to network 14. WAP 58 may be, for example, an IEEE 802.11a, 802.11b, 802.11g, 802.11n, Wi-Fi, and/or Bluetooth device that is capable of establishing wireless communication channel 56 between laptop computer 40 and WAP 58. Personal digital assistant 42 is shown wirelessly coupled to network 14 via wireless communication channel 60 established between personal digital assistant 42 and cellular network/bridge 62, which is shown directly coupled to network 14. Client electronic devices 38, 40, 42, 44 may execute an operating system, examples of which may include but are not limited to Microsoft® Windows®; Mac® OS X®; Red Hat® Linux®, Windows® Mobile, Chrome OS, Blackberry OS, Fire OS, or a custom operating system.

The terminology used herein is for the purpose of describing particular embodiments and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

Although a few example embodiments have been described in detail above, those skilled in the art will readily appreciate that many modifications are possible in the example embodiments without materially departing from the scope of the present disclosure, described herein. Accordingly, such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph (f) for any limitations of any of the claims herein, except for those in which the claim expressly uses the words ‘means for’ or ‘step for’ together with an associated function.

Having thus described the disclosure of the present application in detail and by reference to embodiments thereof, it will be apparent that modifications and variations are possible without departing from the scope of the disclosure defined in the appended claims.

What is claimed is:

1. A computer-implemented method in a tire pressure monitoring system (“TPMS”), comprising:
receiving temperature and history over multiple events of an individual tire;
determining a first indication by comparing a relative temperature between various tires during an operation to predict a tire blow out scenario;
determining a second indication by reviewing decrease in pressure of a wheel of the individual tire over time and comparing the decreased pressure of the wheel with other wheels of the various tires on a vehicle using an algorithm on a system level;
forming predictive analysis based on the first indication and second indication to recommend further manual investigation of a vehicle usability as an aid in a preventive maintenance of the vehicle; and
displaying a recommendation for the preventive maintenance of the vehicle to a user on a user electronic device.

2. The method of claim 1, further comprising calculating a crude mileage by coupling the history over multiple events of the individual tire with data from a length of service of the individual tire, number or roll events and a duration.

3. The method of claim 2, wherein the calculation of the crude mileage determines an early identification of wear or tread depth nearing end of life of the individual tire.

4. The method of claim 1, wherein the relative temperature between the various tires is compared in partnership with at least a tire identification or other derived tire pairing technique.

5. The method of claim 2, further comprising calculating a battery life for a remaining capacity of a battery of the TPMS by using the data from the roll events and the crude mileage.

6. The method of claim 1, wherein the first indication is a precursory indication mechanism in the prediction of the tire blow out scenario.

7. The method of claim 1, wherein the second indication is a puncture indication and the second indication is determined by partnering the first indication with an application for reviewing decrease in pressure of the wheel of the individual tire over time and comparing the decreased pressure of the wheel with the other wheels of the various tires on the vehicle.

8. A non-transitory computer readable storage medium having stored thereon instructions, which when executed by a processor result in one or more operations, the operations comprising:
receiving temperature and history over multiple events of an individual tire;
determining a first indication by comparing a relative temperature between various tires during an operation to predict a tire blow out scenario;
determining a second indication by reviewing decrease in pressure of a wheel of the individual tire over time and comparing the decreased pressure of the wheel with other wheels of the various tires on a vehicle using an algorithm on a system level;
forming predictive analysis based on the first indication and second indication to recommend further manual investigation of a vehicle usability as an aid in a preventive maintenance of the vehicle;
displaying a recommendation for the preventive maintenance of the vehicle to a user on a user electronic device;
calculating a crude mileage by coupling the history over multiple events of the individual tire with data from a length of service of the individual tire, number or roll events and a duration; and
calculating a battery life for a remaining capacity of a battery of the TPMS by using the data from the roll events and the crude mileage.

9. The non-transitory computer readable storage medium of claim 8, wherein the calculation of the crude mileage determines an early identification of wear or tread depth nearing end of life of the individual tire.

10. The non-transitory computer readable storage medium of claim 8, wherein the relative temperature between the various tires are compared in partnership with at least a tire identification or other derived tire pairing technique.

11. The non-transitory computer readable storage medium of claim 8, wherein the first indication is a precursory indication mechanism in the prediction of the tire blow out scenario.

12. The non-transitory computer readable storage medium of claim 8, wherein the second indication is a puncture indication.

13. The non-transitory computer readable storage medium of claim 8, wherein the second indication is a puncture indication and the second indication is determined by partnering the first indication with an application for reviewing decrease in pressure of the wheel of the individual tire over time and comparing the decreased pressure of the wheel with the other wheels of the various tires on the vehicle.

14. A tire pressure monitoring system (“TPMS”) comprising:
a receiver;
a plurality of antilock brake system (ABS) sensors;
an Electronic Control Unit (ECU) including a processor and a storage, wherein the ECU is coupled to the plurality of ABS sensors; and
a plurality of wheel units, wherein at least one wheel unit includes one or more of:
a microcontroller;
a battery;
a transponder coil;
a sensor interface;
a pressure sensor;
a wheel phase angle sensor;
a transmitter; and
an antenna,
where the microcontroller is coupled to the sensor interface and the sensor interface is coupled to the wheel phase angle sensor,
wherein the processor is configured to:
receive temperature and history over multiple events of an individual tire via the receiver;
determine a first indication by comparing a relative temperature between various tires during an operation to predict a tire blow out scenario;
determine a second indication by reviewing decrease in pressure of a wheel of the individual tire over time and comparing the decreased pressure of the wheel with other wheels of the various tires on a vehicle;
form predictive analysis based on the first indication and second indication to recommend further a manual investigation of a vehicle usability as an aid in a preventive maintenance of the vehicle; and
display the recommendation for the preventive maintenance of the vehicle to a user electronic device.

15. The system of claim 14, wherein the processor is further configured to calculate a crude mileage by coupling the history over multiple events of the individual tire with data from a length of service of the individual tire, number or roll events and a duration.

16. The system of claim 15, wherein the calculation of the crude mileage determines an early identification of wear or tread depth nearing end of life of the individual tire.

17. The system of claim 14, wherein the relative temperature between the various tires is compared in partnership with at least a tire identification or other derived tire pairing technique.

18. The system of claim 15, wherein the processor is further configured to calculate a battery life for a remaining capacity of a battery of the TPMS by using the data from the roll events and the crude mileage.

19. The system of claim 14, wherein the first indication is a precursory indication mechanism in the prediction of the tire blow out scenario and the second indication is a puncture indication.

20. The system of claim 14, wherein and the second indication is determined by partnering the first indication with an application for reviewing decrease in pressure of the wheel of the individual tire over time and comparing the decreased pressure of the wheel with the other wheels of the various tires on the vehicle.
